(19) United States
(12) Patent Application Publication
(10) Pub. No.: US 2025/0315500 A1
(43) Pub. Date: Oct. 9, 2025

(54) LAYER NORMALIZATION TECHNIQUES FOR NEURAL NETWORKS

(71) Applicant: TEXAS INSTRUMENTS INCORPORATED, Dallas, TX (US)

(72) Inventors: Deepak Poddar, Bangalore (IN); Pramod Swami, Bangalore (IN); Varun Tripathi, Gurgaon (IN); Shivam Puri, Ghaziabad (IN); Shubham Jain, Neemuch (IN)

(21) Appl. No.: 19/071,564

(22) Filed: Mar. 5, 2025

(30) Foreign Application Priority Data
Apr. 3, 2024 (IN) 202441027618

(51) Int. Cl. G06F 17/16

(52) U.S. Cl. CPC G06F 17/16

(57) ABSTRACT

Various embodiments of the present disclosure relate to performing layer normalization within the context of neural networks, and in particular, to optimizing the operations required to perform layer normalization. In one example embodiment a technique for performing layer normalization is provided. The technique first includes generating a first input matrix and a second input matrix using a plurality of values stored by a feature vector. Next, the technique includes matrix multiplying the first input matrix with the second input matrix to generate an output matrix, such that the output matrix stores a plurality of result values. Finally, the technique includes performing layer normalization for the feature vector using the plurality of result values stored by the output matrix.

### CROSS-REFERENCE TO RELATED APPLICATION

This application is related to, and claims the benefit of priority to, India Provisional Patent Application No 202441027618, filed on Apr. 3, 2024, and entitled “Efficient Layer Normalization in Transformer Networks”, which is hereby incorporated by reference in its entirety.

### TECHNICAL FIELD

Aspects of the disclosure are related to the field of computing hardware and software, and more particularly, to layer normalization.

### BACKGROUND

Layer normalization describes a technique that is utilized by neural networks for normalizing the distribution of data. For example, a neural network may employ layer normalization techniques to standardize the feature data for the layers of the network. Input to layer normalization includes a feature matrix, while the output includes a standardized feature matrix. More specifically, input to layer normalization includes the feature vectors (i.e. rows) from a feature matrix, while the output includes standardized feature vectors, which may be combined to generate the standardized feature matrix.

Current methods for performing layer normalization rely on a series of layers (i.e., software loops) which are configured to calculate normalization parameters for each feature vector within a feature matrix. For example, a first set of layers may be configured to calculate the average for each feature vector within the feature matrix. Once calculated, the first set of layers may subtract the data stored within each feature vector by the respective average. Subsequently, a second set of layers may be configured to receive the output data from the first set of layers, and in response, calculate the standard deviation for each feature vector. Once calculated, the second set of layers may divide the output data for each feature vector by the respective standard deviation.

Problematically, current methods for performing layer normalization are repetitive in nature, as current methods are unable to utilize parallel processing to normalize the data of an entire feature matrix. Instead, current methods for performing layer normalization independently normalize the data of each feature vector within the feature matrix. As a result, current methods for performing layer normalization require a repetitive number of software loops for determining the normalization parameters (e.g., average and standard deviation) for each feature vector within the feature matrix, thereby increasing the processing times and latency for performing layer normalization. In addition, current methods for performing layer normalization increase the required memory bandwidth for a system, as current methods must store intermediate data, such as the averages for each feature vector, within system memory.

### SUMMARY

Disclosed herein is technology, including systems, methods, and devices for performing layer normalization within the context of neural networks. Layer normalization describes a technique for standardizing the data of neural networks by evenly distributing the data across a shared common ground. In various implementations, a technique for optimizing the operations required to perform layer normalization is provided.

In one example embodiment, the technique first includes generating a first input matrix and a second input matrix, such that the first input matrix and the second input matrix store feature vector data. For example, the feature vector may be a vector configured to store a plurality of values, while the first input matrix and the second input matrix are matrices configured to store the plurality of values from the feature vector. In an implementation, a row of the first input matrix is configured to store the plurality of values while a column of the second input matrix is configured to store the plurality of values.

Next, the technique includes matrix-multiplying the first input matrix with the second input matrix to generate an output matrix, such that the output matrix is configured to store a plurality of result values. For example, the technique may include instructing an associated hardware accelerator to matrix-multiply the first input matrix with the second input matrix to generate an output matrix storing the plurality of result values. Finally, the technique includes performing layer normalization for the feature vector using the output matrix.

This Summary is provided to introduce a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a normalization method in an implementation.

FIGS. 3A-3B illustrate a system in an implementation.

FIG. 4 illustrates a hardware accelerator in an implementation.

FIGS. 5A-5D illustrate an operational scenario in an implementation.

FIG. 6 illustrates another operational environment in an implementation.

FIG. 7 illustrates another operational environment in an implementation.

FIG. 8 illustrates another operational environment in an implementation.

FIG. 9 illustrates a computing system suitable for implementing the various operational environments, architectures, processes, scenarios, and sequences discussed below with respect to the other Figures.

### DETAILED DESCRIPTION

Technology is disclosed herein for performing layer normalization within the context of neural networks. Layer normalization describes a technique for standardizing the data of a feature matrix by evenly distributing the data across a shared common ground. Layer normalization may be employed by a variety of networks, including transformer networks, recurrent neural networks (RNNs), convolutional neural networks (CNNs), and other deep neural networks (DNNs) of the like. Input to layer normalization includes the rows of a feature matrix, herein referred to as feature vectors, while the output includes a normalized feature matrix.

Existing techniques for performing layer normalization require a repetitive number of software loops for determining the normalization parameters for normalizing each feature vector within the feature matrix. In the context of layer normalization, the normalization parameters for a feature vector include the average of the feature vector and the standard deviation of the feature vector. As such, existing techniques for performing layer normalization require multiple software loops for independently calculating both the average of each feature vector and the standard deviation of each feature vector, as well as software loops for independently standardizing each feature vector based on the calculated normalization parameters.

For example, processing circuitry configured to perform layer normalization may execute a first software loop, such that the first software loop causes the processing circuitry to calculate the average for each feature vector within the feature matrix. Once calculated, the first software loop may further cause the processing circuitry to subtract the data of each feature vector by the respective average. Next, the processing circuitry is configured to execute a second software loop, such that the second software loop causes the processing circuitry to calculate the standard deviation for each feature vector.

Once calculated, the processing circuitry is configured to execute a third software loop, such that the third software loop causes the processing circuitry to divide the output of the first software loop by the output of the second software loop. Meaning that, the third software loop causes the processing circuitry to divide each of the reduced feature vectors by the respective standard deviation. Finally, the processing circuitry is configured to execute a fourth software loop, such that the fourth software loop causes the processing circuitry to scale the output of the third software loop by learnable parameters. For example, the fourth software loop may cause the processing circuitry to generate a first output by performing a multiplication operation between the output of the third software loop and a first learnable parameter. Additionally, the fourth software loop may also cause the processing circuitry to generate a final output by performing an addition operation between the first output of the fourth software loop and a second learnable parameter.

Consequently, existing techniques for performing layer normalization are inefficient due to the method in which the normalization parameters are calculated. For example, if the feature matrix is a 200×150 matrix, then to perform layer normalization, the processing circuitry must execute the first software loop 200 times, then execute the second software loop 200 times, then execute the third software loop 200 times, and then finally execute the fourth software loop 200 times. Meaning that, the processing circuitry must execute a minimum of 800 software loops to perform layer normalization for a feature matrix which includes 200 feature vectors.

In addition, existing techniques for executing layer normalization increase the required memory bandwidth of the associated system, as existing techniques store intermediate data (i.e., output data of the software loops) in system memory. In contrast, disclosed herein is a new technique for performing layer normalization which leverages hardware for calculating the normalization parameters, and by design, can reduce the number of software loops, and in turn, the number of data transfers to and from memory, as well as the processing times for performing layer normalization.

In one example embodiment a computer-readable medium having executable instructions related to performing layer normalization is provided. The instructions are configured to be executed by processing circuitry, such that when executed, the instructions cause the processing circuitry to efficiently calculate the normalization parameters of a feature matrix and perform layer normalization with respect to the calculated normalization parameters.

In an implementation, the program instructions first cause the processing circuitry to obtain a feature vector storing a plurality of values from memory. For example, the processing circuitry may obtain, from memory, a first row of values from an associated feature matrix. Next, the program instructions cause the processing circuitry to, using the feature vector, generate a first input matrix and a second input matrix, such that the first input matrix and the second input matrix store the plurality of values. In an implementation, to generate the first input matrix the processing circuitry is configured to arrange the plurality of values of the feature matrix within a row of the first input matrix. For example, if the feature vector is storing 24 values, and the first input matrix is a 1×64 matrix, then the processing circuitry may be configured to populate the first 24 entries of the first input matrix with the 24 values of the feature vector and populate the remaining 40 entries of the first input matrix with zero.

Alternatively, to generate the second input matrix, the processing circuitry is configured to arrange the plurality of values of the feature vector within a column of the second input matrix. For example, if the feature vector is storing 24 values, and the second input matrix is a 64×64 matrix, then the processing circuitry may be configured to populate the first column of the matrix with zeros, populate the first 24 entries of the second column with ones, populate the third column with zeros, populate the first 24 entries of the fourth column with the 24 values of the feature vector, and populate the remaining entries of the second input matrix with zeros. Once populated, the processing circuitry is configured to matrix-multiply the first input matrix with the second input matrix to produce an output matrix, such that the output matrix stores a plurality of result values.

It should be noted that if the number of values stored by the feature vector is greater than the number of entries within a row of the first input matrix, or the number of entries within a column of the second input matrix, then the program instructions cause the processing circuitry to generate additional input matrices for the matrix multiplication operation. For example, if the processing circuitry is configured to generate 1×32 or 32×32 matrices, and the feature vector includes 50 values, then the program instructions first cause the processing circuitry to generate a first 1×32 input matrix storing the first 32 values of the feature vector and a second 1×32 input matrix storing the remaining 18 values of the feature vector. Next, the program instructions cause the processing circuitry to generate a first 32×32 input matrix and a second 32×32 input matrix such that the first column of the first 32×32 input matrix stores zeros, the second column of the first 32×32 input matrix stores ones, the third column of the first 32×32 input matrix stores zeros, and the fourth column of the first 32×32 input matrix stores the first 32 values of the feature vector, and additionally, the first column of the second 32×32 input matrix stores zeros, the first 18 entries of the second column of the second 32×32 input matrix stores ones, the third column of the second 32×32 input matrix stores zeros, and the first 18 entries of the fourth column of the second 32×32 input matrix stores the remaining 18 values of the feature vector. Once generated, the processing circuitry may matrix-multiply the first 1×32 input matrix with the first 32×32 input matrix, and matrix-multiply the second 1×32 matrix with the second 32×32 input matrix to generate output matrices storing a plurality of result values.

In an implementation, to perform the matrix multiplication, the processing circuitry is configured to instruct an associated hardware accelerator to perform the matrix multiplication operations. For example, the processing circuitry may be coupled to a matrix multiplication accelerator (MMA), and configured to instruct the matrix multiplication accelerator to matrix multiply a first input matrix with a second input matrix to generate an output matrix storing a plurality of result values. In an implementation, after instructing the associated hardware accelerator to perform the matrix multiplication operations, the processing circuitry is further configured to instruct the associated hardware accelerator to process the plurality of result values to generate normalization parameters for the feature vector.

For example, the processing circuitry may instruct the MMA to scale the plurality of result values by the number of values stored within the feature vector. Meaning if the feature vector is storing 24 values, then the processing circuitry is configured to instruct the MMA to divide each result value within the plurality of result values by 24. As a result, within a single software loop, the MMA generates normalization parameters for the feature vector, such that the normalization parameters include an average of the feature vector and a squared average of the feature vector.

In an implementation, after determining the normalization parameters for the feature vector, the processing circuitry is configured to instruct the associated hardware accelerator to determine a variance for the feature vector based on the normalization parameters. For example, the processing circuitry may instruct the MMA to calculate the variance for the feature vector by subtracting the squared average of the feature vector with the average of the feature vector squared.

Once calculated, the program instructions cause the processing circuitry to perform layer normalization for the feature vector using the average and the variance of the feature vector. As a result, the processing circuitry is configured to output a normalized feature vector. In an implementation, the program instructions cause the processing circuitry to produce a normalized feature vector for each feature vector within a feature matrix. For example, if a feature matrix consists of 300 feature vectors, then the processing circuitry is configured to generate normalization parameters for the 300 feature vectors, generate 300 normalized feature vectors based on the respective normalization parameters, and combine the 300 normalized feature vectors to generate a normalized feature matrix.

Advantageously, the proposed technology provides a technique which leverages a hardware accelerator for calculating the normalization parameters of a feature vector within a single software loop. As a result, the proposed technology can reduce the latency, processing load, power consumption, and processing times for performing layer normalization, as compared to the other approaches. In addition, the proposed technology can reduce the amount of data transfers within memory, thereby improving the computation time and memory bandwidth of the associated system.

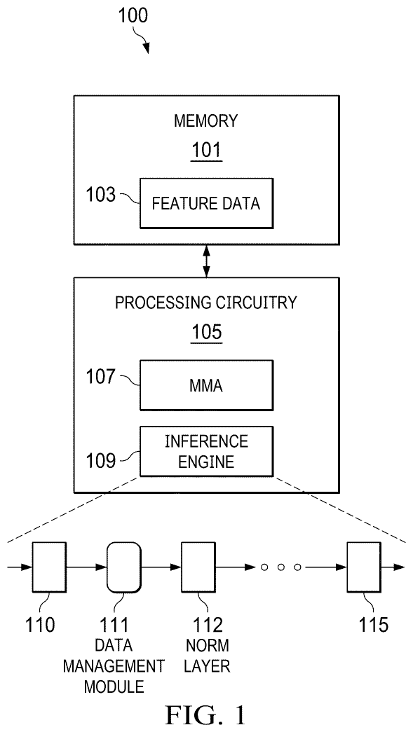

Now turning to the figures, FIG. 1 illustrates operating environment 100 in an implementation. Operating environment 100 is representative of an example environment configurable to perform layer normalization within the context of a neural network. For example, operating environment 100 may be a system configured to perform layer normalization within the context of a transformer network, RNN, CNN, or another DNN of the like. Operating environment 100 may be implemented in a variety of use-cases, including automotive, industrial, robotics, language processing, autonomous systems, or another application of the like which utilizes layer normalization. Operating environment 100 includes, but is not limited to, memory 101 and processing circuitry 105.

Memory 101 is representative of one or more volatile or non-volatile computer-readable storage media including instructions, data, and the like. For example, memory 101 may be static random-access memory (SRAM), dynamic random-access memory (DRAM), flash memory, or another memory of the like configured to store the data for processing circuitry 105. It should be noted that memory 101 may be either an on-chip or off-chip memory. For example, processing circuitry may include memory 101, such that processing circuitry 105 is configured to store feature data 103 in memory 101. Alternatively, memory 101 may be a system memory that is configured to store feature data 103.

Feature data 103 represents the data for the layers of a neural network. For example, feature data 103 may include the input data, the intermediate data, or the output data for the layers of inference engine 109. In an implementation, feature data 103 is stored in memory 101 based on the dimensions of the data. For example, if feature data 103 includes a feature matrix, then memory 101 is configured to store the data from the first row of the feature matrix, then store the data from the second row of the feature matrix, and so on, until memory 101 stores the data from each row of the feature matrix. In other words, memory 101 is configured to store each feature vector of the feature matrix. In an implementation, processing circuitry 105 is configured to access feature data 103 from memory 101 and provide the data to inference engine 109.

Processing circuitry 105 is representative of circuitry configured to execute a neural network. For example, processing circuitry 105 may be a central processing unit (CPU), application-specific integrated circuit (ASIC), digital signal processor (DSP), microcontroller unit (MCU), graphics processing unit (GPU), tensor processing unit (TPU), or another general-purpose processor (GPP) of the like configured to perform object detection, image classification, image segmentation, or another task of the like. Processing circuitry 105 includes, but is not limited to, matrix multiplication accelerator (MMA) 107 and inference engine 109.

MMA 107 is representative of circuitry configured to perform fixed-point computations. For example, MMA 107 may be a hardware accelerator configured to perform matrix multiplication operations. In an implementation, MMA 107 is configured to perform the matrix multiplication operations of inference engine 109.

Inference engine 109 is representative of circuitry configured to execute the layers of a neural network. For example, inference engine 109 may be a CPU, ASIC, DSP, MCU, GPU, TPU, or another GPP of the like configured to execute the layers of a transformer network, RNN, CNN, or another DNN of the like. In an implementation, inference engine 109 is configured to perform layer normalization within the context of a neural network. For example, inference engine 109 may be a transformer network which employs layer normalization techniques to perform a designated task. Inference engine 109 comprises multiple layers, including, but not limited to, layer 110, data management module 111, normalization layer 112, and layer 115.

Layer 110 represents a processing block of a neural network. For example, if inference engine 109 is a transformer network, then layer 110 may be a multi-headed attention block (MHAB) which is configured to compute the scaled dot-product attention of a feature matrix. In an implementation, layer 110 is configured to provide its output data to data management module 111. For example, layer 110 may store its output within memory 101, for access by data management module 111.

Data management module 111 is representative of a processing block which is configured to obtain input data for performing layer normalization. For example, data management module 111 may be configured to obtain normalization parameters for performing the layer normalization of normalization layer 112. The normalization parameters describe values which allow normalization layer 112 to standardize the data of a feature vector. For example, the normalization parameters for an associated feature vector may include an average of the feature vector and a squared average of the feature vector.

In an implementation, to obtain the normalization parameters for a feature vector, data management module 111 is configured to format the data of a feature vector into a first input matrix and a second input matrix and provide the first and second input matrices to MMA 107. In response, MMA 107 matrix multiplies the first input matrix with the second input matrix to generate an output matrix. Next, MMA 107 processes the output matrix to generate the normalization parameters for the feature vector. Once generated, the normalization parameters for the feature vector are supplied as input to normalization layer 112.

Normalization layer 112 is representative of a processing block which is configured to normalize feature data. For example, normalization layer 112 may be configured to normalize the data of a feature matrix to generate a normalized feature matrix. In an implementation, to normalize the data of a feature matrix, normalization layer 112 is configured to normalize the data of each feature vector within the feature matrix to generate a set of normalized feature vectors. Once generated, normalization layer 112 may combine the set of normalized feature vectors to generate a normalized feature matrix. In an implementation, normalization layer 112 provides the normalized feature matrix to a next layer of the network. For example, normalization layer 112 may provide the normalized feature matrix to a matrix multiplication layer. Alternatively, normalization layer 112 may provide the normalized feature matrix to layer 115.

Layer 115 is representative of a processing block which is configured to form the output of inference engine 109. For example, if inference engine 109 is configured to perform image classification, then layer 115 may be configured to output a classification for an input image.

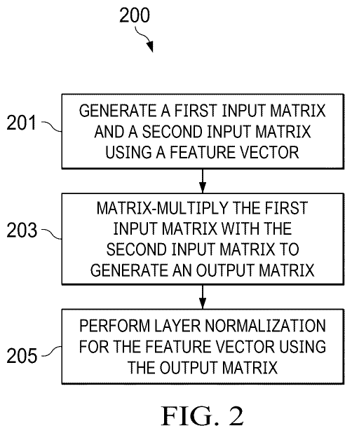

FIG. 2 illustrates normalization method 200 in an implementation. Normalization method 200 is representative of software for performing layer normalization within the context of a neural network. Normalization method 200 may be implemented in the context of program instructions that, when executed by a suitable computing system, direct the processing circuitry of the computing system to operate as follows, referring parenthetically to the steps in FIG. 2. For the purposes of explanation, normalization method 200 will be explained with the elements of FIG. 1. This is not meant to limit the applications of normalization method 200, but rather to provide an example.

To begin, data management module 111 obtains a feature vector from memory 101 and generates a first input matrix and a second input matrix using the data of the feature vector (step 201). For example, if layer 110 outputs a feature matrix to memory 101, then data management module 111 may obtain the data from the first row of the feature matrix and generate a first input matrix and a second input matrix using the data from the first row.

In an implementation, to generate the first input matrix, data management module 111 is configured to arrange the data of the feature vector into a row of the first input matrix. For example, if the feature vector is storing 60 values, and the first input matrix is a 1×64 matrix, then data management module 111 may be configured to populate the first 60 entries of the first input matrix with the data of the feature vector and populate the remaining four entries of the first input matrix with zeros. Alternatively, to generate the second input matrix, data management module 111 is configured to arrange the data of the feature vector into a column of the second input matrix. For example, if the feature vector is storing 60 values, and the second input matrix is a 64×64 matrix, then data management module 111 may be configured to populate the first column of the second input matrix with zeros, populate the first 60 entries of the second column with ones, populate the third column with zeros, populate the first 60 entries of the fourth column with the data of the feature vector, and populate the remaining entries of the second input matrix with zeros.

In another implementation, MMA 107 is instead configured to generate the first and second input matrices. For example, after layer 110 stores its output in memory 101, data management module 111 may instruct MMA 107 to obtain a feature vector from memory 101 and generate the first and second input matrices using the feature vector. In either case, after generating the first and second input matrices, MMA 107 is configured to matrix multiply the first input matrix with the second input matrix to generate an output matrix (step 203).

The output matrix is representative of a matrix storing a plurality of result values. In an implementation, after generating the output matrix, MMA 107 is configured to process the output matrix to generate normalization parameters for performing layer normalization. For example, MMA 107 may be configured to determine the number of values stored by the feature vector and scale the output matrix by the number of values within the feature vector. Meaning if the feature vector is storing 60 values, then MMA 107 is configured to divide the data of the output matrix by 60. As a result, MMA 107 determines an average for the feature vector and a squared average for the feature vector. In other words, MMA 107 generates normalization parameters for the feature vector.

In an implementation, after generating the normalization parameters for the feature vector, MMA 107 is configured to provide the normalization parameters for the feature vector to normalization layer 112, and in response, normalization layer 112 is configured to perform layer normalization for the feature vector using the normalization parameters (step 205). For example, normalization layer 112 may execute the following equation with respect to the feature vector:

$$layernorm ( x ) = \frac{x - E ( x )}{\sqrt{E ( {x}^{2} ) - {( E ( x ) )}^{2} + ϵ}} γ + β \qquad ( 1 )$$

Such that in Equation (1), x is representative of the feature vector, E(x) is representative of the average for the feature vector, E(x²) is representative of the squared average for the feature vector, ∈ is representative of an additive constant, γ is representative of a learnable parameter, and β is representative of another learnable parameter. The expression E(x²)−(E(x))² may be representative of the variance for the feature vector.

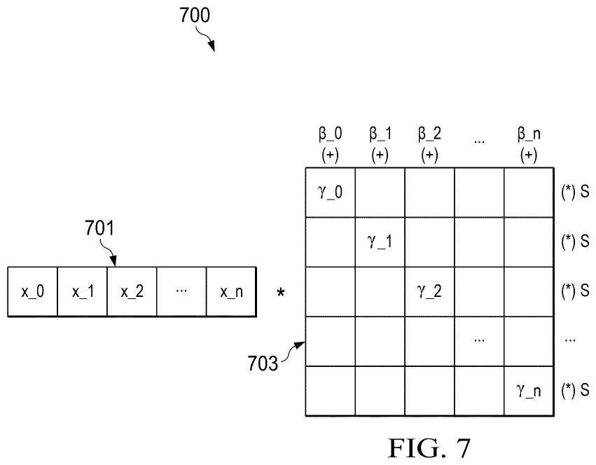

Meaning that, normalization layer 112 is first configured to reduce the data of the feature vector by the average for the feature vector. Once reduced, normalization layer 112 is configured to compute the standard deviation for the feature vector using the squared average for the feature vector, the average for the feature vector, and the additive constant. Next, normalization layer 112 is configured to divide the data of the reduced feature vector by the standard deviation for the feature vector. Finally, normalization layer 112 is configured to scale the processed feature vector using the learnable parameters, later discussed in detail with reference to FIG. 7. In an implementation, normalization layer 112 is configured to instruct MMA 107 to execute the fixed-point computations of Equation (1). For example, MMA 107 may reduce the data of the feature vector, divide the reduced feature vector by the standard deviation, and scale the processed feature vector by the learnable parameters.

Once normalized, data management module 111 may obtain a next feature vector from memory 101 to restart normalization process 200. For example, if the first feature vector represented the first row of a feature matrix, then the next feature vector may represent the second row of the feature matrix. In an implementation, normalization process 200 is performed for each feature vector of a feature matrix. For example, to normalize the data of a 90×60 feature matrix, normalization process 200 must be executed a total of 90 times.

In another implementation, after generating the normalization parameters for the feature vector, MMA 107 is configured to generate normalization parameters for the next feature vector within the feature matrix. For example, if the feature matrix is a 90×60 matrix, then MMA 107 may be configured to generate normalization parameters for each of the 90 feature vectors within the feature matrix. Once generated, MMA 107 may provide the normalization parameters for each feature vector to normalization layer 112, and in response, normalization layer 112 may perform layer normalization for each feature vector within the feature matrix. As a result, normalization layer 112 outputs 90 normalized feature vectors, which may be combined to generate the normalized feature matrix.

Advantageously, normalization method 200 employs hardware to determine the normalization parameters for a feature vector, thereby reducing the processing times, latency, and the computational overhead for performing layer normalization. In addition, normalization method 200 reduces the amount of data transfers within memory, which reduces the required memory bandwidth of the associated system, and further reduces the processing times for performing layer normalization.

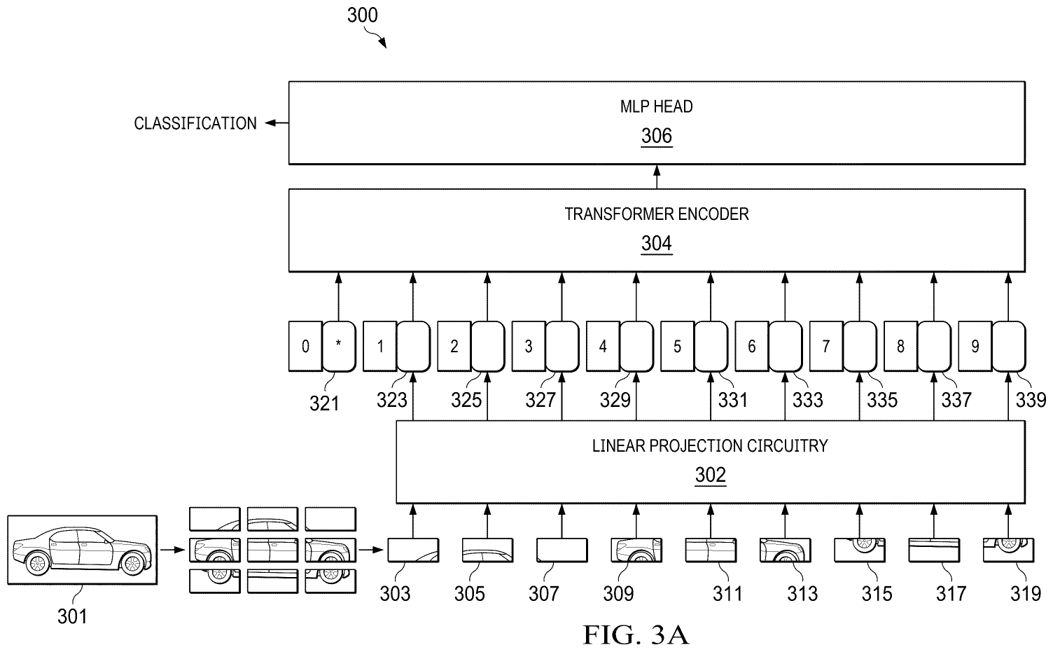

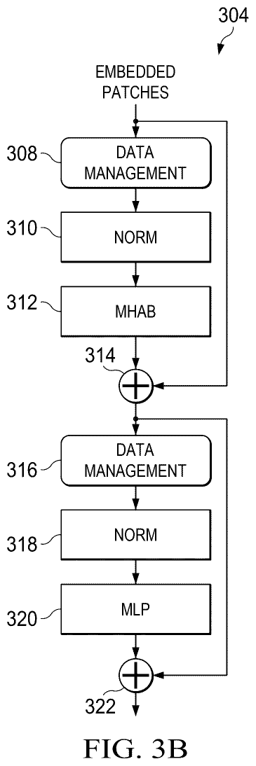

Now turning to the next figure, FIG. 3A illustrates system 300 in an implementation. System 300 is representative of a transformer network which employs layer normalization techniques to perform a designated task. For example, system 300 may represent operating environment 100 of FIG. 1. In an implementation, system 300 is configured to employ layer normalization techniques for performing image classification. System 300 includes, but is not limited to, image 301, linear projection circuitry 302, transformer encoder 304, and multi-layer perceptron (MLP) network 306.

Image 301 represents the input data for the transformer network. For example, system 300 may be coupled to a camera configured to collect image data of an environment. In an implementation, a camera coupled to system 300 is configured to supply system 300 with image 301, and in response, system 300 is configured to divide image 301 into image patches 303, 305, 307, 309, 311, 313, 315, 317 and 319. Image patches 303, 305, 307, 309, 311, 313, 315, 317 and 319 are sections of image data which correspond to image 301. In an implementation, image patches 303, 305, 307, 309, 311, 313, 315, 317 and 319 are provided as input to linear projection circuitry 302.

Linear projection circuitry 302 is representative of circuitry configured to embed image data into a format which may be provided to a transformer encoder. For example, linear projection circuitry 302 may be configured to embed image patches 303, 305, 307, 309, 311, 313, 315, 317 and 319 into representations which may be fed to transformer encoder 304. In an implementation, linear projection circuitry 302 is configured to embed image patches 303, 305, 307, 309, 311, 313, 315, 317 and 319 into a number of image matrices or a number of image vectors. In either case, the output of linear projection circuitry 302 includes embedded patches 323, 325, 327, 329, 331, 333, 335, 337, and 339.

Embedded patches 323, 325, 327, 329, 331, 333, 335, 337, and 339 are representative of patches of embedded image data. For example, embedded patches 323, 325, 327, 329, 331, 333, 335, 337, and 339 may include matrices which respectively store the embedded image data of image patches 303, 305, 307, 309, 311, 313, 315, 317 and 319. For the purposes of explanation, embedded patches 323, 325, 327, 329, 331, 333, 335, 337, and 339 represent image matrices. This is not meant to limit the applications of the proposed technology, but rather to provide an example.

In an implementation, prior to outputting the embedded patches, linear projection circuitry 302 is configured to label embedded patches 323, 325, 327, 329, 331, 333, 335, 337, and 339 with positional embeddings. For example, linear projection circuitry may sequentially label the embedded patches, such that embedded patch 323 is labeled as “1”, embedded patch 325 is labeled as “2”, and so on. Once labeled, linear projection circuitry 302 may provide embedded patches 323, 325, 327, 329, 331, 333, 335, 337, and 339 as input to transformer encoder 304.

Transformer encoder 304 is representative of a deep learning architecture which is configured to employ layer normalization techniques for performing the task of system 300. For example, transformer encoder 304 may be representative of inference engine 109 of FIG. 1. Input to transformer encoder 304 includes the output of linear projection circuitry 302, as well as classification embedding 321.

Classification embedding 321 is representative of learnable data generated during the training stage of system 300. For example, if system 300 is trained to classify images within the automotive context, then classification embedding 321 may provide data which allows transformer encoder 304 to classify vehicles, pedestrians, traffic lights, and other surroundings of the like. In an implementation, linear projection circuitry 302 is configured to label classification embedding 321 with a positional embedding. For example, linear projection circuitry may label classification embedding as “0”. It should be noted that classification embedding 321 may be an alternative learnable embedding (e.g., detection embedding), but for the purposes of explanation, classification embedding 321 will be discussed herein.

In an implementation, transformer encoder receives classification embedding 321 and embedded patches 323, 325, 327, 329, 331, 333, 335, 337, and 339, and in response, generates an attention-based output. For example, transformer encoder 304 may generate a matrix which stores the final attention scores for image 301. The final attention scores include data which assigns a relevance to the image data captured by image 301. The relevance of the image data describes the importance of the image data within the context of the task that system 300 is configured to perform. In an implementation, after generating the final attention scores matrix, transformer encoder 304 is configured to provide its output to MLP network 306.

MLP network 306 is representative of a deep learning network which is configured to form the output of system 300. For example, MLP network 306 may comprise multiple layers configured to classify the data of image 301. In an implementation, MLP network 306 is configured to classify image 301 based on the output of transformer encoder 304. For example, MLP network 306 may classify image 301 as a car based on the final attention scores matrix generated by transformer encoder 304.

FIG. 3B illustrates the layers of transformer encoder 304 in an implementation. The layers of transformer encoder 304 are processing layers which are configured to execute various operations for performing the task of system 300. For example, if system 300 is configured to perform image classification, then the layers of transformer encoder 304 may be configured to execute various fixed-point operations related to the classification of an image.

In an implementation, transformer encoder 304 is configured to offload the fixed-point computations of its processing layers to an associated hardware accelerator. For example, system 300 may be coupled to an MMA (e.g., MMA 107) configured to execute the various fixed-point computations for the layers of transformer encoder 304. Transformer encoder 304 includes, but is not limited to, data management layer 308, normalization layer 310, multi-headed attention block (MHAB) 312, summation layer 314, data management layer 316, normalization layer 318, multi-layer perceptron (MLP) 320, and summation layer 322.

Data management layer 308 is representative of a processing layer which is configured to generate the normalization parameters for a feature matrix. For example, data management layer 308 may be representative of data management module 111 of FIG. 1. Input to data management layer 308 includes embedded patches 323, 325, 327, 329, 331, 333, 335, 337, and 339, while the output of data management layer 308 includes normalization parameters for each of the embedded patches. For the purposes of explanation, embedded patches 323, 325, 327, 329, 331, 333, 335, 337, and 339 describe matrices. This is not meant to limit the applications of the proposed technology, but rather to provide an example.

In an implementation, to generate the normalization parameters for an embedded patch, data management layer 308 is configured to generate normalization parameters for each vector within the embedded patch. For example, to generate normalization parameters for embedded patch 323, data management layer 308 is first configured to divide embedded patch 323 into a number of embedded vectors. Once divided, data management layer 308 is configured to, for each embedded vector of embedded patch 323, generate a first input matrix and a second input matrix based on the data of each embedded vector.

In an implementation, to generate the first and second input matrices for an embedded vector, data management layer 308 is configured to arrange the data of the embedded vector into a row of the first input matrix and arrange the data into a column of the second input matrix. For example, if the embedded vector is a 1×24 vector, and the first input matrix is a 1×64 matrix, and the second input matrix is a 64×64 matrix, then data management layer 308 may populate the first 24 entries of the first input matrix with the data of the embedded vector and populate the remaining entries of the first input matrix with zero. Data management layer 308 may further populate the first column of the second input matrix with zeros, populate the first 24 entries of the second column with ones, populate the third column with zeros, populate the first 24 entries of the fourth column with the data from the embedded vector, and populate the remaining entries of the matrix with zeros. In an implementation, after generating the first and second input matrices, data management layer 308 is configured to supply the matrices to an associated hardware accelerator to cause the associated hardware accelerator to generate normalization parameters for the embedded vector.

For example, data management layer 308 may provide the first and second input matrices to an MMA, and in response, the MMA may matrix multiply the first input matrix with the second input matrix to generate an output matrix. Once generated, the MMA may process the output matrix to generate normalization parameters for the embedded vector. For example, the MMA may determine the number of values stored by the embedded vector and scale the output matrix by the number of values within the embedded vector. Meaning if the embedded vector is storing 24 values, then the MMA is configured to divide the data of the output matrix by 24. As a result, the MMA determines an average for the embedded vector and a squared average for the embedded vector. In other words, the MMA generates normalization parameters for the embedded vector.

In an implementation, data management layer 308 is configured to generate a first input matrix and a second input matrix for each embedded vector of embedded patches 323, 325, 327, 329, 331, 333, 335, 337, and 339. Once generated, data management layer 308 is configured to supply the first input matrices and the second input matrices to an associated hardware accelerator to cause the associated hardware accelerator to generate normalization parameters for each of the embedded vectors of embedded patches 323, 325, 327, 329, 331, 333, 335, 337, and 339. For example, data management layer 308 may supply the first and second input matrices to an MMA configured to generate normalization parameters based on the first and second input matrices. Output of the MMA may then be supplied to normalization layer 310 to cause normalization layer 310 to normalize the data of embedded patches 323, 325, 327, 329, 331, 333, 335, 337, and 339.

Normalization layer 310 is representative of a processing layer configured to perform layer normalization. For example, normalization layer 310 may be representative of normalization layer 112 of FIG. 1. Input to normalization layer 310 includes embedded patches 323, 325, 327, 329, 331, 333, 335, 337, and 339, and the normalization parameters for each embedded vector of embedded patches 323, 325, 327, 329, 331, 333, 335, 337, and 339. Alternatively, output of normalization layer 310 includes normalized versions of embedded patches 323, 325, 327, 329, 331, 333, 335, 337, and 339.

In an implementation, to perform the layer normalization of normalization layer 310, normalization layer 310 is configured to, for a first embedded vector, execute Equation (1). Meaning, normalization layer 310 is configured to reduce the data of the first embedded vector by the average for the vector. Once reduced, normalization layer 310 is configured to compute the standard deviation for the vector using the squared average for the vector, the average for the vector, and the additive constant. Next, normalization layer 310 is configured to divide the data of the reduced vector by the standard deviation for the vector. Finally, normalization layer 310 is configured to scale the processed feature vector using learnable parameters. In an implementation, normalization layer 310 is configured to offload its operations to an associated hardware accelerator. For example, normalization layer 310 may instruct an MMA to execute Equation (1) for each embedded vector of embedded patches 323, 325, 327, 329, 331, 333, 335, 337, and 339. As a result, normalization layer 310 generates normalized patches of data, which are supplied as input to MHAB 312.

MHAB 312 is representative of a processing block configured to execute a multi-headed attention mechanism. For example, MHAB 312 may be configured to calculate the scaled dot-product attention for the output of normalization layer 310. In an implementation, MHAB 312 comprises multiple processing layers configured to calculate the scaled dot-product attention for each normalized patch output by normalization layer 310. For example, MHAB 312 may include a first matrix multiplication layer, a SoftMax layer, and a second matrix multiplication layer. Output of MHAB 312 includes a final attention scores matrix. The final attention scores matrix is a matrix which stores the final attention scores for each of the normalized patches. For example, if normalization layer 310 outputs nine normalized patches, then the output of MHAB 312 includes a matrix which stores the final attention scores for each of the nine normalized patches. In an implementation, MHAB 312 is configured to provide its output to summation layer 314.

Summation layer 314 is representative of a processing layer which is configured to sum the output of MHAB 312 with the data of embedded patches 323, 325, 327, 329, 331, 333, 335, 337, and 339. In an implementation, the summation operation of summation layer 314 is performed by an associated hardware accelerator. For example, summation layer 314 may instruct an MMA to sum the output of MHAB 312 with the data of embedded patches 323, 325, 327, 329, 331, 333, 335, 337, and 339. Output of summation layer 314 is provided as input to data management layer 316.

Data management layer 316 is representative of another processing layer which is configured to generate the normalization parameters for a feature matrix. For example, data management layer 316 may be representative of data management module 111 of FIG. 1. In an implementation, data management layer 316 is configured to generate the normalization parameters for the matrices output by summation layer 314.

For example, for each matrix output by summation layer 314, data management layer 316 is configured to divide the matrices into a number of vectors, and for each vector, generate a first input matrix and a second input matrix based on the data of the vectors. Next, data management layer 316 is configured to supply the first and second input matrices to an associated hardware accelerator to cause the associated hardware accelerator to generate normalization parameters for each of the vectors. For example, data management layer 316 may supply the first and second input matrices to an MMA configured to generate output matrices by matrix multiplying the first input matrices with the respective second input matrices and generate normalization parameters for each of the vectors by processing the output matrices. Once generated, the MMA may supply the normalization parameters as input to normalization layer 318.

Normalization layer 318 is representative of another processing layer configured to perform layer normalization. For example, normalization layer 318 may be representative of normalization layer 112 of FIG. 1. In an implementation, to perform the layer normalization of normalization layer 318, normalization layer 318 is configured to, for a first vector, execute Equation (1). Meaning, normalization layer 318 is configured to reduce the data of the vector by the average for the vector, compute the standard deviation for the vector using the squared average for the vector, the average for the vector, and the additive constant, divide the data of the reduced vector by the standard deviation for the vector, and scale the processed feature vector using learnable parameters. In an implementation, normalization layer 318 is configured to offload its operations to an associated hardware accelerator. For example, normalization layer 318 may instruct an MMA to execute Equation (1) for each vector output by summation layer 314. As a result, normalization layer 310 generates normalized patches of data, which are supplied as input to MLP 320.

MLP 320 is representative of a processing block which is configured to linearize the output of normalization layer 318. For example, MLP 320 may linearize the normalized data output by normalization layer 318. Output of MLP 320 is provided as input to summation layer 322.

Summation layer 322 is representative of a processing layer which is configured to sum the output of summation layer 314 with the output of MLP 320. In an implementation, the summation operation of summation layer 322 is performed by an associated hardware accelerator. For example, summation layer 322 may instruct an MMA to sum the output of summation layer 314 with the output of MLP 320. In an implementation, the output of summation layer 322 is provided as input to a next layer of transformer encoder 304. For example, summation layer 322 may provide its output to a next data management layer. In another implementation, output of summation layer 322 is provided as input to MLP network 306.

Additional example details for executing the layers of transformer encoders can be found in commonly assigned U.S. patent application Ser. No. 18/917,252, entitled “Optimization of Transformer Encoders”, filed Oct. 16, 2024, which is incorporated by reference in its entirety.

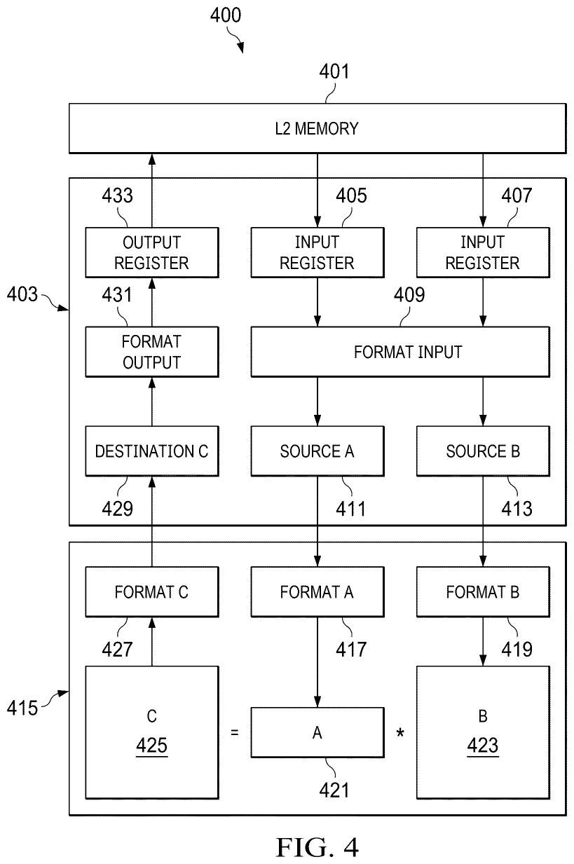

FIG. 4 illustrates hardware accelerator 400 in an implementation. Hardware accelerator 400 is representative of circuitry configured to perform fixed-point computations. For example, hardware accelerator 400 may be configured to perform the fixed-point computations of a neural network. In an implementation, hardware accelerator 400 is configured to generate normalization parameters for performing layer normalization. For example, hardware accelerator 400 may be representative of MMA 107 of FIG. 1. Hardware accelerator 400 includes, but is not limited to, L2 memory 401, DSP 403, and MMA 415.

L2 memory 401 is representative of a memory configured to store data for the layers of a neural network. For example, L2 memory 401 may be representative of memory 101 of FIG. 1. In an implementation, L2 memory 401 is configured to store the feature data (e.g., feature data 103) for the layers of a neural network. For example, L2 memory 401 may be configured to store a feature matrix comprising multiple feature vectors. In an implementation, DSP 403 is configured to access feature data from L2 memory 401 to generate normalization parameters for performing layer normalization.

DSP 403 is representative of circuitry configured to arrange the data of a feature matrix into a format which may be supplied to MMA 415. For example, DSP 403 may be configured to obtain a feature matrix from L2 memory 401, format the feature matrix into a number of feature vectors, and supply the number of feature vectors to MMA 415. DSP 403 includes, but is not limited to, input registers 405 and 407, format input block 409, source A register 411, and source B register 413.

Input registers 405 and 407 are representative of registers configured to store the data of a feature matrix. For example, DSP 403 may access a feature matrix from L2 memory 401, and store the accessed feature matrix within input registers 405 and 407. Once stored, format input block 409 may access the data from input registers 405 and 407.

Format input block 409 is representative of circuitry configured to format the data of a feature matrix into a number of feature vectors. For example, if the feature matrix stored by input registers 405 and 407 is a 40×60 matrix, then format input block 409 may be configured to format the data of the feature matrix into 40 separate feature vectors. In an implementation, after dividing the data of a feature matrix into a number of feature vectors, format input block 409 is configured to supply a first feature vector from the number of feature vectors to source A register 411 and source B register 413. For example, if format input block 409 divides the feature matrix into 40 feature vectors, then format input block 409 may be configured to supply the first feature vector of the 40 feature vectors to source A register 411 and source B register 413.

Source A register 411 and source B register 413 are representative of registers configured to store the data of a feature vector. For example, format input block 409 may be configured to access a feature vector from input registers 405 and 407 and store the accessed feature vector within source A register 411 and source B register 413. Once stored, MMA 415 may access the feature vector data from source A register 411 and source B register 413 and generate normalization parameters for the feature vector.

MMA 415 is representative of circuitry configured to perform fixed-point computations, such as matrix multiplication operations. In an implementation MMA 415 is configured to generate normalization parameters for a feature vector. For example, MMA 415 may be representative of MMA 107 of FIG. 1. MMA 415 includes, but is not limited to, format A block 417, format B block 419, input matrix 421, and input matrix 423.

Format A block 417 is representative of a processing block which is configured to format the data of a feature vector into a first input matrix. For example, format A block 417 may be configured to access feature vector data from source A register 411 and populate input matrix 421 with data from the feature vector. In an implementation, to populate input matrix 421, format A block 417 is configured to populate a row of input matrix 421 with the data of the feature vector. For example, if the feature vector is a 1×60 vector, and input matrix 421 is a 1×64 matrix, then format A block 417 may be configured to populate the first 60 entries of matrix 421 with the data of the feature vector, and populate the remaining 4 entries of matrix 421 with zeros.

Similarly, format B block 419 is representative of a processing block which is configured to format the data of a feature vector into a second input matrix. For example, format B block 419 may be configured to access feature vector data from source B register 413 and populate input matrix 423 with the data from the feature vector. In an implementation, to populate input matrix 423, format B block 419 is configured to populate a column of input matrix 423 with the data of the feature vector. For example, if the feature vector is a 1×60 vector, and input matrix 423 is a 64×64 matrix, then format A block 417 may be configured to populate the first column of input matrix 423 with zeros, populate the first 60 entries of the second column with ones, populate the third column with zeros, populate the first 60 entries of the fourth column with the data from the feature vector, and populate the remaining entries of input matrix 423 with zeros.

In an implementation, after populating input matrices 421 and 423, MMA 415 is configured to matrix multiply input matrix 421 with input matrix 423. As a result, MMA 415 generates output matrix 425, such that output matrix 425 is a 1×64 matrix storing a plurality of result values. In an implementation, after generating output matrix 425, format C block 427 is configured to generate normalization parameters for the feature matrix using the data of output matrix 425.

Format C block 427 is representative of circuitry configured to generate normalization parameters for a feature vector. For example, after MMA 415 generates output matrix 425, format C block 427 may be configured to process the data of output matrix 425 to generate an average for the feature vector and a squared average for the feature vector. In an implementation to process the data of output matrix 425, format C block 427 is configured to determine a number of values within the feature vector and divide the data of output matrix 425 by the number of values within the feature vector. For example, if the feature vector includes 60 values, then format C block 427 is configured to divide the data of output matrix 425 by 60. As a result, format C block 427 generates the average for the feature vector and the squared average for the feature vector.

In an implementation format C block 427 is further configured to quantize the data of output matrix 425. For example, if output matrix 425 is storing 32-bit data, then format C block 427 may be configured to quantize the data from the 32-bit precision to the 16-bit precision. In an implementation, to quantize data from the 32-bit precision to the 16-bit precision, format C block 427 is configured to treat output matrix 425 as a 1×32 matrix storing 64-bit data. Advantageously, treating output matrix 425 as a 1×32 matrix storing 64-bit data (rather than 1×64 matrix storing 32-bit data) allows format C block 427 to quantize the data from the 32-bit precision to the 16-bit precision in a single cycle. Output of format C block 427 is stored by destination C register 429.

Destination C register 429 is representative of a register configured to store the normalization parameters for a feature vector. For example, after generating the average for a feature vector, and the squared average for the feature vector, format C block 427 is configured to store the average for the feature vector and the squared average for the feature vector within destination C register 429. In an implementation, destination C register 429 is configured to supply the normalization parameters for a feature vector to format output block 431.

Format output block 431 is representative of a processing block which is configured to format the normalization parameters for a feature matrix. For example, format output block 431 may be configured to receive the normalization parameters for each feature vector within a feature matrix. In response, format output block 431 may be configured to organize the received normalization parameters to generate a set of normalization parameters for the feature matrix. Output of format output block 431 is supplied to output register 433.

Output register 433 is representative of a register configured to store the normalization parameters of feature matrix. In an implementation DSP 403 is configured to store the data of output register 433 within L2 memory 401. For example, after format output block 431 stores the normalization parameters for the feature matrix within output register 433, DSP 403 may be configured to store the data of output register 433 within L2 memory 401. In an another implementation, DSP 403 is configured to supply the data stored by output register 433 to a normalization layer. For example, if hardware accelerator 400 is configured to perform the fixed-point computations of system 300, then DSP 403 may supply the normalization parameters stored by output register 433 to normalization layer 310.

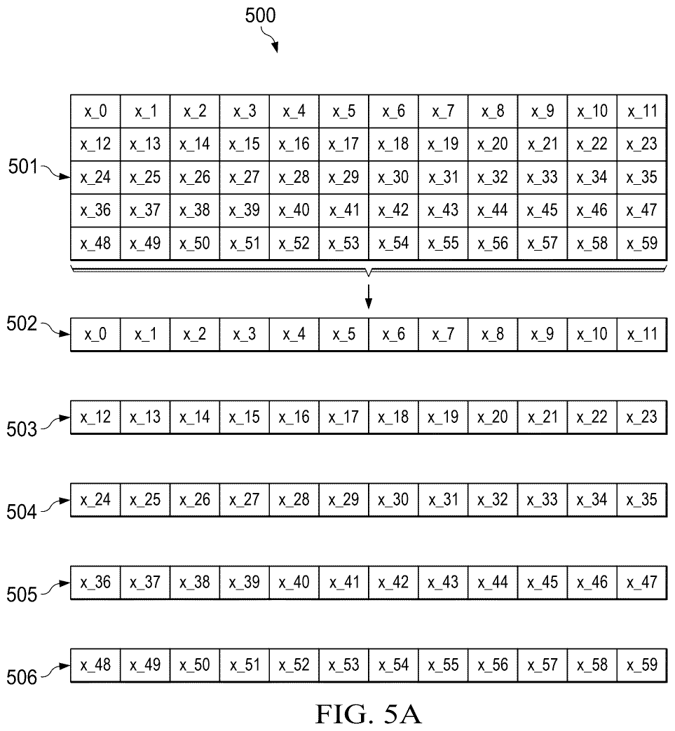

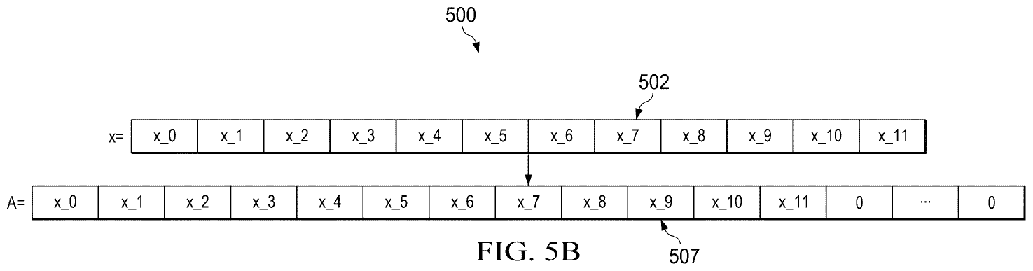

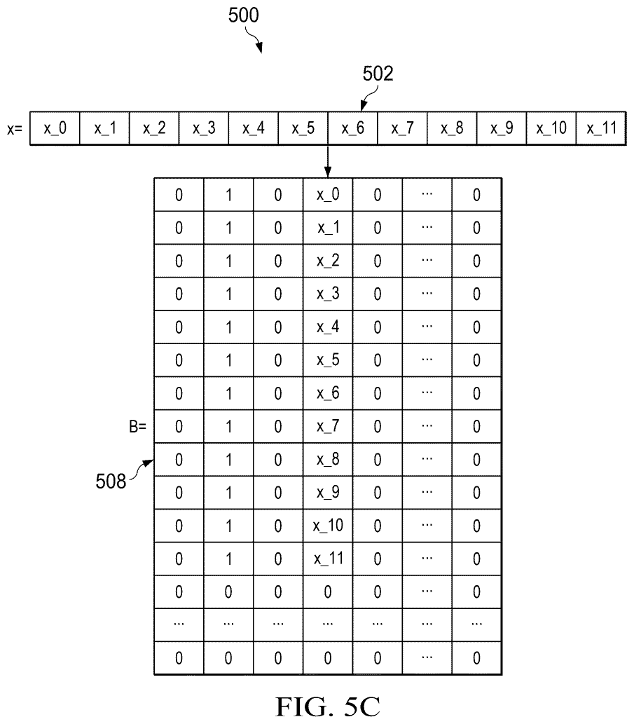

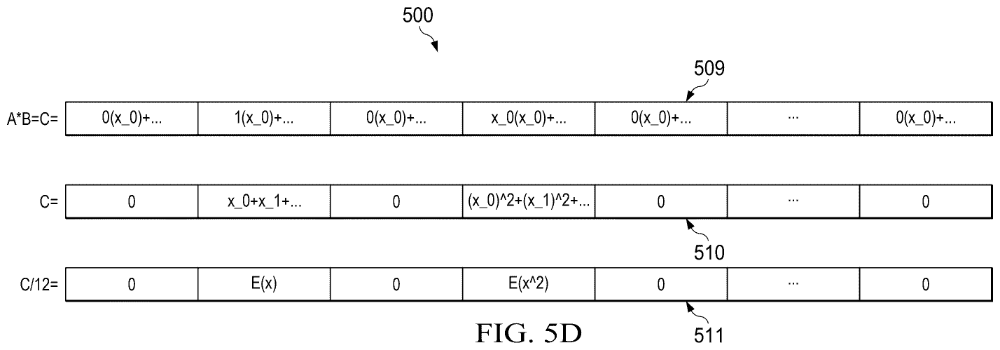

FIGS. 5A-5D illustrate operational scenario 500 in an implementation. Operational scenario 500 is representative of a scenario for generating the normalization parameters for a feature vector. For example, operational scenario 500 may be representative of a scenario for hardware accelerator 400. In an implementation, operational scenario 500 includes four stages. The first stage, depicted by FIG. 5A, is representative of scenario for dividing a feature matrix into a number of feature vectors. The second stage, depicted by FIG. 5B, is representative of a scenario for generating a first input matrix. The third stage, depicted by FIG. 5C, is representative of a scenario for generating a second input matrix. The fourth and final stage, depicted by FIG. 5D, is representative of a scenario for generating the normalization parameters for the feature vector.

Now turning to the first stage, FIG. 5A includes feature matrix 501 and feature vectors 502, 503, 504, 505, and 506. Feature matrix 501 is a 5×12 matrix that is configured to store 8-bit or 16-bit feature data. For example, feature matrix 501 may store the output data from a layer of a neural network (e.g., layer 110). Alternatively, feature matrix 501 may store the output data from a sensor interface. For example, feature matrix 501 may store image data collected by an associated camera.

In an implementation, processing circuitry configured to generate normalization parameters for a feature matrix is configured to divide feature matrix 501 into a number of feature vectors based on the rows of feature matrix 501. For example, within the context of hardware accelerator 400, format input block 409 may be configured to divide feature matrix 501 into feature vectors 502, 503, 504, 505, and 506.

Feature vectors 502, 503, 504, 505, and 506 represent the rows of feature matrix 501, such that feature vector 502 is the first row of feature matrix 501, feature vector 503 is the second row, feature vector 504 is the third row, feature vector 505 is the fourth row, and feature vector 506 is the fifth row of feature matrix 501. In an implementation, after dividing the rows of feature matrix 501 into feature vectors 502, 503, 504, 505, and 506, the processing circuitry is configured to generate normalization parameters for each of the feature vectors.

Now turning to the next stage of operational scenario 500, FIG. 5B includes feature vector 502 and input matrix 507. Input matrix 507 is representative of an input to a hardware accelerator such that input matrix 507 is a 1×64 matrix. For example, input matrix 507 may be representative of input matrix 421 of FIG. 4. In an implementation, processing circuitry configured to generate the normalization parameters for feature vector 502 is configured to populate input matrix 507 with the data of feature vector 502. For example, within the context of hardware accelerator 400, format A block 417 may populate the first 12 entries of input matrix 507 with the data of feature vector 502 and populate the remaining entries of input matrix 507 with zeros.

Turning now to the third stage, FIG. 5C includes feature vector 502 and input matrix 508. Input matrix 508 is representative of an input to a hardware accelerator such that input matrix 508 is a 64×64 matrix. For example, input matrix 508 may be representative of input matrix 423 of FIG. 4. In an implementation, processing circuitry configured to generate the normalization parameters for feature vector 502 is configured to populate input matrix 508 with the data of feature vector 502. For example, within the context of hardware accelerator 400, format B block 419 may populate the first column of input matrix 508 with zeros, populate the first 12 entries of the second column with ones, populate the third column with zeros, populate the first 12 entries of the fourth column with the data from feature vector 502, and populate the remaining entries of input matrix 508 with zeros.

Now turning to the final stage, FIG. 5D includes output matrices 509, 510, and 511. Output matrices 509, 510, and 511 represent the results from matrix multiplying and further processing input matrices 507 and 508, such that output matrices 509, 510, and 511 are 1×64 matrices. In an implementation, processing circuitry configured to generate normalization parameters for a feature vector is first configured to matrix multiply input matrix 507 with input matrix 508. For example, within the context of FIG. 4, MMA 415 may be configured to matrix multiply input matrix 507 with input matrix 508 to generate output matrix 509, and in turn, output matrix 510. Next, format C block 427 is configured to process output matrix 510 to generate normalization parameters for feature vector 502. For example, format C block 427 may determine that feature vector 502 is storing 12 values and, divide the data of output matrix 510 by 12. As a result, format C block 427 generates output matrix 511, such that output matrix 511 stores the average of feature vector 502 (i.e., E(x)), and the squared average of feature vector 502 (i.e., E(x\hat{ }2)). In other words, output matrix 511 stores the normalization parameters for feature vector 502. The variance of the feature vector 502 can be computed using the normalization parameters, i.e., the average of feature vector 502 and the squared average of feature vector 502.

In an implementation, operational scenario 500 is executed for each feature vector of feature matrix 501. Meaning that, operational scenario 500 would need to be executed a total of five times to generate the normalization parameters for feature vectors 502, 503, 504, 505, and 506.

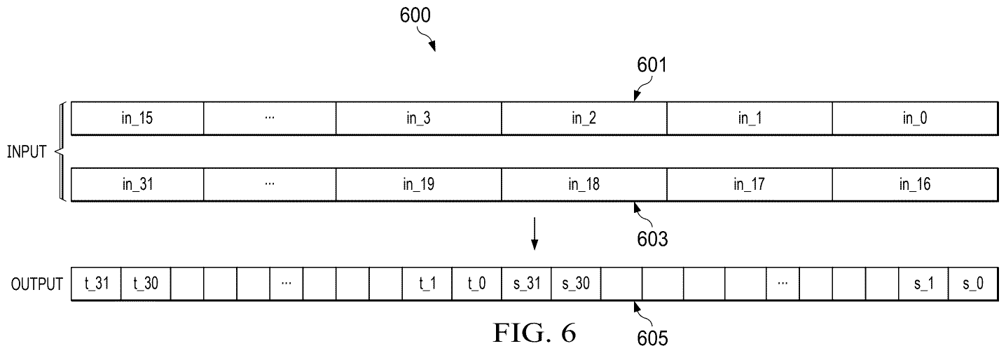

FIG. 6 illustrates operating environment 600 in an implementation. Operating environment 600 is representative of an exemplary environment for converting floating-point multiplication and division operations into fixed-point multiplication operations. For example, operating environment 600 may be representative of an environment for extracting the scale value and the shift value from a 32-bit floating-point number. Operating environment 600 includes input vector 601, input vector 603, and output vector 605.

Input vectors 601 and 603 are representative of vectors that are configured to store floating-point data. For example, input vectors 601 and 603 may be configured to store 32-bit floating-point data. In an implementation, input vectors 601 and 603 are the inputs for processing circuitry configured to extract the scale value and shift value from a floating-point number. For example, the processing circuitry may be configured to perform floating-point multiplication/division operations via a series of scale and shift operations.

In an implementation, input vectors 601 and 603 are configured to store the normalization parameters for the feature vectors of a feature matrix. For example, if the feature matrix is a 32×200 matrix, then input vectors 601 and 603 may each include 16 entries, such that the entries of input vectors 601 and 603 are respectively configured to store the following value for each of the 32 feature vectors of the feature matrix:

$$f = \frac{1}{\sqrt{E ( {x}^{2} ) - {( E ( x ) )}^{2} + ϵ}} \qquad ( 2 )$$

Such that in Equation (2), f represents a 32-bit floating-point number, E(x) represents the average for a feature vector, E(x²) represents the squared average for the feature vector, and ∈ represents an additive constant. In an implementation, f represents a 32-bit floating-point number that meets the IEEE-754 standard. For example, the first bit of f may represent the sign of the floating-point number, the next eight bits of f may represent the scale or exponent of the floating-point number, and the remaining 23 bits of f may represent the mantissa of the floating-point number.

In an implementation, after input vectors 601 and 603 have been populated with the normalization parameters (i.e., in_n) for a feature matrix, input vectors 601 and 603 may be supplied as input to processing circuitry configured to extract the scale (i.e., s_n) and shift values (i.e., t_n) for each feature vector within input vectors 601 and 603. Output of the processing circuitry includes output vector 605, such that output vector 605 is a vector which stores the scale (i.e., s_0, s_1, . . . , s_30, and s_31) and shift values (i.e., t_0, t_1, . . . , t_30, and t_31) for each floating-point number within input vectors 601 and 603. For example, output vector 605 may store the scale and shift values for the normalization parameters of the feature vectors from a feature matrix.

Advantageously, operating environment 600 illustrates a scenario for converting the floating-point division operation of Equation (1) into a fixed-point multiplication operation in a precise and computationally efficient manner. For example, within the context of FIG. 1, after normalization layer 112 reduces the values of a feature vector by the average for the feature vector, normalization layer 112 may instruct MMA 107 to execute Equation (2) for the feature vector. Once executed, MMA 107 may be configured to extract the scale and shift values for the feature vector, and as a result generate output vector 605 for the feature vector, such that output vector 605 efficiently stores the scale and shift values for the feature vector. MMA 107 may then utilize output vector 605 to divide the reduced feature vector by the standard deviation for the feature vector. It should be noted that operating environment 600 is not limited to applications related to layer normalization, and instead provides a scenario for converting any floating-point multiplication/division operation into a fixed-point multiplication operation.

FIG. 7 illustrates operating environment 700 in an implementation. Operating environment 700 is representative of an example environment for performing layer normalization within the context of a neural network. For example, operating environment 700 may be representative of an environment for executing Equation (1). In an implementation, operating environment 700 is representative of an environment for scaling a normalized feature vector using the learnable parameters (i.e., γ and β). Within the context of layer normalization, the learnable parameters are values which are generated during the training stage of a neural network, such that the learnable parameters allow the network to scale and shift a respective feature vector. Operating environment 700 includes feature vector 701 and scaling matrix 703.

Feature vector 701 is representative of a vector configured to store feature data from an associated feature matrix. For example, feature vector 701 may be representative of feature vector 502 of FIG. 5A. In an implementation, feature vector 701 is a partially normalized feature vector, such that the data of feature vector 701 is processed feature data. For example, the data of feature vector 701 may be data obtained from executing the following equation:

$${x}^{′} = \frac{x - E ( x )}{\sqrt{E ( {x}^{2} ) - {( E ( x ) )}^{2} + ϵ}} \qquad ( 3 )$$

Such that in Equation (3), x′ is representative of a partially normalized feature vector (e.g., feature vector 701), x is representative of the feature vector, E(x) is representative of the average for the feature vector, E(x²) is representative of the squared average for the feature vector, and ∈ is representative of an additive constant that provides numerical stability. In an implementation, to complete the layer normalization for feature vector 701, processing circuitry associated with operating environment 700 is configured to matrix multiply feature vector 701 with scaling matrix 703. For example, MMA 107 of FIG. 1 or hardware accelerator 400 of FIG. 4 may be configured to matrix multiply feature vector 701 with scaling matrix 703.

Scaling matrix 703 is representative of a matrix configured to store the learnable parameters for a feature vector (i.e., γ and β). For example, scaling matrix 703 may store the gamma values (i.e., γ_0, γ_1, . . . , γ_n) and bias values (i.e., β_0, β_1, . . . β_n) for a respective feature vector. In an implementation, scaling matrix 703 is populated during the training phase of a neural network. For example, processing circuitry configured to train a neural network may populate scaling matrix 703 with the gamma values (i.e., γ₀, γ₁, . . . , γ_n) and bias values (i.e., β_0, β_1, . . . , β_n), such that the gamma values are floating-point numbers. Next the processing circuitry is configured to convert the floating-point data of scaling matrix 703 to fixed-point data via common factors (i.e. S). The common factor describes an 8-bit quantity which allows the processing circuitry to represent the gamma values as 8-bit data.

In a brief operational example, processing circuitry associated with operating environment 700 is first configured to matrix multiply feature vector 701 with scaling matrix 703. For example, within the context of FIG. 1, MMA 107 may matrix multiply feature vector 701 with scaling matrix 703 to generate an output matrix. Next, MMA 107 may add the bias term to the rows of the output matrix. Finally, MMA 107 may scale the entries of the output matrix with the respective common factor. As a result, MMA 107 generates a normalized version of feature vector 701.

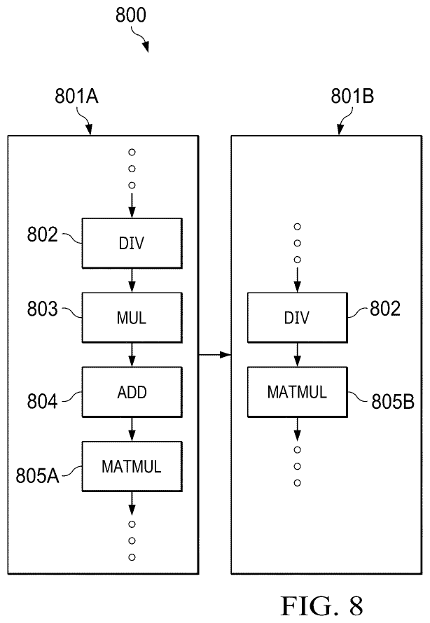

FIG. 8 illustrates operating environment 800 in an implementation. Operating environment 800 is representative of an environment configured to compile a network which employs layer normalization techniques. For example, operating environment 800 may be representative of an environment for compiling the network of inference engine 109, or the transformer network of system 300. Operating environment 800 includes network 801A and compiled network 801B.

Network 801A is representative of a neural network that has yet to be compiled. For example, network 801A may be an uncompiled transformer network, RNN, CNN, or another DNN of the liked. Network 801A includes division layer 802, multiplication layer 803, addition layer 804, and matrix multiplication layer 805A.

Division layer 802 is representative of a processing layer configured to perform a division operation. For example, within the context of layer normalization, division layer 802 may be configured to divide the data of a reduced feature vector by the standard deviation for the feature vector. Output of division layer 802 is supplied as input to multiplication layer 803.

Multiplication layer 803 is representative of a processing layer configured to perform a multiplication operation. For example, within the context of layer normalization, multiplication layer 803 may be configured to multiply the data of a processed feature vector by the gamma values for the feature vector. Multiplication with gamma values and addition with bias values are precision sensitive operations. Output of multiplication layer 803 is supplied as input to addition layer 804.

Addition layer 804 is representative of a processing layer configured to perform an addition operation. For example, within the context of layer normalization, addition layer 804 may be configured to add the bias values to the data of a processed feature. Output of multiplication layer 803 includes the normalized feature vector, which is supplied as input to matrix multiplication layer 805A.

Matrix multiplication layer 805A is representative of a processing layer that is configured to perform a matrix multiplication operation. For example, matrix multiplication layer 805A may be configured to matrix multiply a normalized feature matrix with the data from a weight matrix. Output of matrix multiplication layer 805A is provided as input to a next layer of the network.

In an implementation, to compile network 801A, the processing circuitry is first configured to identify the matrix multiplication layers which fall subsequent to multiplication and/or addition layers. For example, the processing circuitry may identify matrix multiplication layer 805A. Once identified, the processing circuitry is configured to adjust the weight matrix of matrix multiplication layer 805A to include the learnable parameters from multiplication layer 803 and addition layer 804. For example, within the context of operating environment 700, the processing circuitry may update the weight values of matrix multiplication layer 805A to include scaling matrix 703. Once updated, the processing circuitry may compile the network to generate compiled network 801B.

Compiled network 801B is representative of the compiled version of network 801A, such that compiled network 801B includes division layer 802 and matrix multiplication layer 805B. Matrix multiplication layer 805B is representative of a processing layer that is configured to normalize a partially normalized feature matrix by scaling the partially normalized feature matrix with the learnable parameters for the feature matrix. In addition, matrix multiplication layer 805B is also configured to matrix multiply the normalized feature matrix with the weight matrix of multiplication layer 805B. It should be noted that compiled network 801B no longer includes multiplication layer 803 and addition layer 804, as matrix multiplication layer 805B is capable of performing a matrix multiplication operation and the operations of multiplication layer 803 and addition layer 804 at no additional cost.

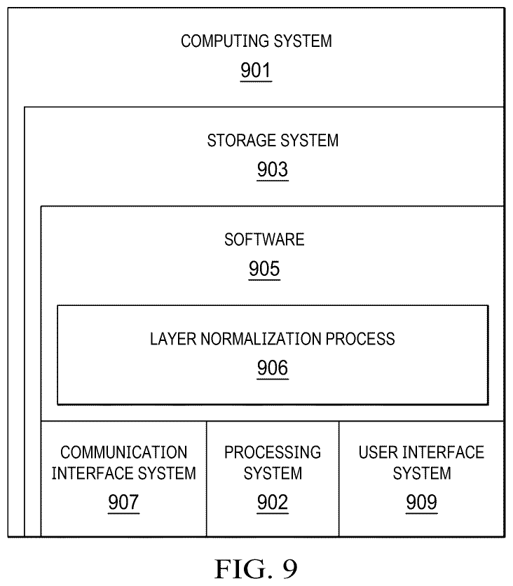

FIG. 9 illustrates an example computer system that may be used in various implementations. For example, computing system 901 is representative of a computing device capable of efficiently performing layer normalization within the context of a neural network as described herein. Computing system 901 is representative of any system or collection of systems with which the various operational architectures, processes, scenarios, and sequences disclosed herein for determining the normalization parameters for performing layer normalization may be employed. Examples of computing system 901 include—but are not limited to—micro controller units (MCUs), embedded computing devices, server computers, cloud computers, personal computers, mobile phones, and the like.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909 (optional). Processing system 902 is operatively coupled with storage system 903, communication interface system 907, and user interface system 909. Computing system 901 may be representative of a cloud computing device, distributed computing device, or the like.

Processing system 902 loads and executes software 905 from storage system 903, or alternatively, runs software 905 directly from storage system 903. Software 905 includes program instructions, which includes layer normalization process 906 (e.g., normalization method 200). When executed by processing system 902, software 905 directs processing system 902 to operate as described herein for at least the various processes, operational scenarios, and sequences discussed in the foregoing implementations. Computing device 901 may optionally include additional devices, features, or functions not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, digital signal processing units, data processing units, application specific processors, and logic devices, as well as any other type of processing device, combinations, or variations thereof.

Storage system 903 may comprise any computer readable storage media readable and writeable by processing system 902 and capable of storing software 905. Storage system 903 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support binary convolution operations. Indeed, encoding software 905 (and layer normalization process 906) on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary, etc.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A device comprising:
a memory configured to store a feature vector including a plurality of values;
formatting circuitry coupled to the memory and configurable to generate, using the feature vector, a first input matrix and a second input matrix, wherein the first input matrix and the second input matrix include the plurality of values;
a matrix multiplication accelerator coupled to the formatting circuitry and configurable to matrix-multiply the first input matrix with the second input matrix to produce an output matrix including a plurality of result values; and
layer normalization circuitry coupled to the matrix multiplication accelerator and configurable to perform layer normalization for the feature vector using the output matrix.

2. The device of claim 1, wherein the matrix multiplication accelerator is further configurable to:
determine a number of values within the plurality of values; and
produce normalization parameters for the feature vector by scaling the plurality of result values by the number of values.

3. The device of claim 2, wherein the matrix multiplication accelerator is further configurable to, using the normalization parameters, determine a variance for the feature vector.

4. The device of claim 3, wherein the layer normalization circuitry is further configurable to perform the layer normalization for the feature vector using the variance.

5. The device of claim 4, wherein the normalization parameters include an average value of the plurality of result values and an average of a squared value of the plurality of result values.

6. The device of claim 1,
wherein the plurality of values is arranged as a row in the first input matrix, and
wherein the plurality of values is arranged as a column in the second input matrix.

7. The device of claim 6, wherein the first input matrix includes:
a first row including the plurality of values; and
wherein the second input matrix includes:
a first column including a first plurality of zeros;
a second column including a plurality of ones;
a third column including a second plurality of zeros; and
a fourth column including the plurality of values.

8. The device of claim 1,
wherein the first input matrix has a bit depth of eight bits;
wherein the output matrix comprises a row including the plurality of result values; and
wherein the output matrix has a bit depth of sixteen bits.

9. The device of claim 1, further comprising a hardware accelerator configured as the matrix multiplication accelerator.

10. The device of claim 9, wherein the hardware accelerator includes the formatting circuitry configurable to generate the first input matrix and the second input matrix.

11. A system comprising:
one or more processing cores configurable to:
identify a feature vector stored in memory wherein the feature vector includes a plurality of values; and
generate, using the feature vector, a first input matrix and a second input matrix,
wherein the first input matrix and the second input matrix include the plurality of values; and
hardware accelerator circuitry operatively coupled with the one or more processing cores and configurable to:
matrix-multiply the first input matrix with the second input matrix to produce an output matrix including a plurality of result values; and
supply the output matrix to the one or more processing cores to cause the one or more processing cores to perform layer normalization for the feature vector using the output matrix.

12. The system of claim 11, wherein the hardware accelerator circuitry is further configurable to:
determine a number of values within the plurality of values;
produce normalization parameters for the feature vector by scaling the plurality of result values by the number of values;
determine a variance for the feature vector using the normalization parameters; and
supply the variance to the one or more processing cores to cause the one or more processing cores to perform the layer normalization for the feature vector using the variance.

13. The system of claim 12, wherein the normalization parameters include an average value of the plurality of result values and an average of a squared value of the plurality of result values.

14. The system of claim 11,
wherein the plurality of values is arranged as a row in the first input matrix, and
wherein the plurality of values is arranged as a column in the second input matrix.

15. The system of claim 14, wherein the first input matrix includes:
a first row including the plurality of values;
wherein the second input matrix includes:
a first column including a first plurality of zeros;
a second column including a plurality of ones;
a third column including a second plurality of zeros; and
a fourth column including the plurality of values; and
wherein the output matrix includes:
a row including the plurality of result values.

16. A non-transitory computer-readable medium having program instructions stored thereon, configured to be executable by processing circuitry comprised of core processing circuitry and hardware accelerator circuitry, and wherein the program instructions, when executed by the processing circuitry, causes the processing circuitry to at least:
by the core processing circuitry:
identify a feature vector stored in memory wherein the feature vector includes a plurality of values; and
generate, using the feature vector, a first input matrix and a second input matrix,
wherein the first input matrix and the second input matrix include the plurality of values; and
by the hardware accelerator circuitry:
matrix-multiply the first input matrix with the second input matrix to produce an output matrix including a plurality of result values; and
supply the output matrix to the core processing circuitry to cause the core processing circuitry to perform layer normalization for the feature vector using the output matrix.

17. The non-transitory computer-readable medium of claim 16, wherein the program instructions are executable by the processing circuitry for further causing the processing circuitry to:
by the hardware accelerator circuitry:
determine a number of values within the plurality of values;
produce normalization parameters for the feature vector by scaling the plurality of result values by the number of values;
determine a variance for the feature vector using the normalization parameters; and
supply the variance to the core processing circuitry to cause the core processing circuitry to perform the layer normalization for the feature vector using the variance.

18. The non-transitory computer-readable medium of claim 17, wherein the normalization parameters include an average value of the plurality of result values and an average of a squared value of the plurality of result values.

19. The non-transitory computer-readable medium of claim 16,
wherein the plurality of values is arranged as a row in the first input matrix, and
wherein the plurality of values is arranged as a column in the second input matrix.

20. The non-transitory computer-readable medium of claim 19, wherein the first input matrix includes:
a first row including the plurality of values;
wherein the second input matrix includes:
a first column including a first plurality of zeros;
a second column including a plurality of ones;
a third column including a second plurality of zeros; and
a fourth column including the plurality of values; and
wherein the output matrix includes:
a row including the plurality of result values.
